(19) United States
(12) Patent Application Publication
(10) Pub. No.: US 2006/0112633 A1
(43) Pub. Date: Jun. 1, 2006

(54) Illuminated plant holders

(76) Inventors: Neall Humphrey, Reno, NV (US); Yu-Yo Yen, Taipei (TW)

Correspondence Address: Greenberg Traurig, LLP, 2450 Colorado Avenue, Suite 400E, Santa Monica, CA, 90404, US

(21) Appl. No.: 10/989,934

(22) Filed: Nov. 15, 2004

(51) Int. Cl. A47G 7/00; A01G 9/02

(52) U.S. Cl. 47/66.6; 47/39

(57) ABSTRACT

An illuminated plant holder having a base holding a plant, real or simulated, with a light source associated with the plant for illuminating the same. The light source may be incandescent or fluorescent, solar powered, high or low voltage, battery operated, high intensity, or LEDs.

### BACKGROUND OF THE INVENTION

1. Field of the Invention

The invention relates to plant holders; and, more particularly, to illuminated real or simulated holders for plants, flowers, etc.

2. Related Art

Various types of holders for holding plants and flowers are well known. Such plants or flowers may be real or simulated and the holders may be self-supported or adapted to be hung from a hook or the like. Some plants require some sort of light, natural or artificial, to survive. Further, people who display such plants or flowers usually try to locate them in an area where there is light to display the same in an aesthetically pleasing appearance.

There is thus a need for plant holders, self-supporting or hanging, that have self-contained illumination focused on the plant for illuminating the same.

### SUMMARY OF THE INVENTION

It is an object of this invention to provide a plant holder having built in illumination.

It is a further object of this invention to provide a stand for a plant having illuminating means that may have an incandescent, solar, high-intensity or fluorescent light source.

These and other objects are preferably accomplished by providing a plant holder that is either self-supporting or adapted to be hung from a hook or the like and is illuminated.

### BRIEF DESCRIPTION OF THE DRAWINGS

FIG. 1 is an elevational view of a self-supported plant holder in accordance with the teachings of the invention;

FIG. 2 is a detailed view of part of the holder of FIG. 1 illustrating another type of lighting means; and

FIGS. 3 to 5 are elevational views, similar to FIG. 1, illustrating 3 different types of plant holders in accordance with the teachings of the invention.

### DETAILED DESCRIPTION OF THE PREFERRED EMBODIMENTS

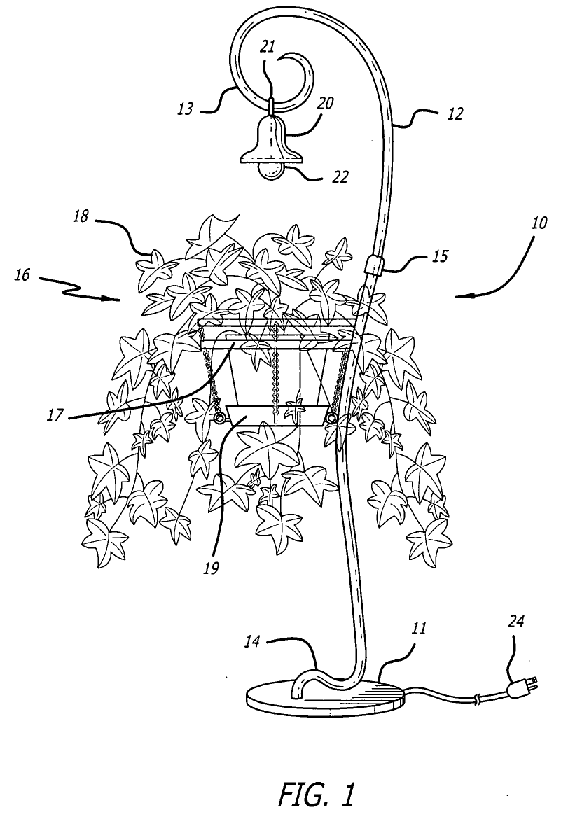

Referring now to FIG. 1 of the drawing, a plant holder 10 in accordance with the teachings of the invention is shown. Holder 10 has a base 11, which may be a round desk of metal or any other suitable material, adapted to rest on a supporting surface. A supporting pole 12 is fixed at one end to base 11 extending upwardly therefrom to a curved upper end 13. Pole 12 may have a curved portion 14 at bottom where it connects to base 11 and may be one piece or comprised of one or more interconnected sections joined together by a connector, such as connector 15. Thus, pole 12 may be tubular, curved at top and bottom as shown, and comprised of 2 pieces interconnected at collar 15.

A plant holder 16 hangs downwardly from curved portion 13. Plant holder 16 hangs downwardly from curved portion 13. Plant holder 16 has a pot 17 with a plant 18, real or simulated, mounted therein. A drip pan 19 may be at the bottom of pot 17 for containing water placed in pot 17 or simulating a drip pan (if plant 18 is artificial, for example).

Plant holder 16 has an upper crown portion 20 hanging from curved portion 13 by a hook 21. As particularly contemplated in the present invention, crown portion 20 may include a light socket (not shown) on the interior thereof receiving therein a removable light bulb 22. Pot 17 may be attached to pole 12 in any suitable manner.

It is to be understood that any suitable means may be used to provide electricity to bulb 22. For example, crown portion 20 may have a battery mounted therein actuated by a switch. Electrical conduits may be coupled to the socket in crown portion 20 and may extend through pole 12, which may be hollow, to base 11. A plug 24 may be connected to such a conduit for plugging into a socket and providing electricity to bulb 22. An on-off switch (not shown) may be mounted on base 11, or crown portion 20, for selectively turning on and off bulb 22.

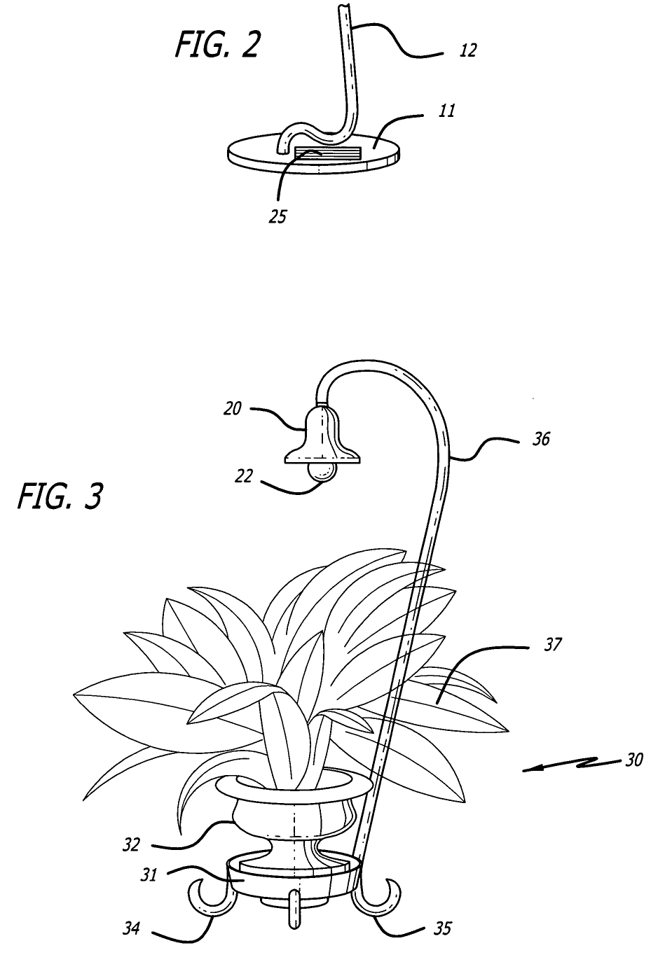

Other suitable lighting means may be provided. For example, as seen in FIG. 2, wherein like numerals refer to like numbers of the holder 10 of FIG. 1, a solar panel 25 may be mounted on base 11 for using solar energy to light bulb 22.

Although bulb 22 is shown as an incandescent bulb, it may be a high intensity bulb, a fluorescent bulb, etc.

“Plant is” used herein to refer to any real or simulated vegetation, such as flowers, plants, etc. that one may wish to display in one's home or garden or the like.

Although a plant holder is shown in FIG. 1 as having a flat base for supporting the same on a supporting surface, the base may have a plurality of legs supporting the same. Thus, as seen in FIG. 3, wherein like numerals refer to like parts of the embodiment of FIG. 1, plant holder 30 has a stand 31 with an ornate pot 32 supported therein. A plant 37 is disposed in the pot 32. A plurality of curved supporting legs 34 are fixed to the underside of stand 31. One leg, such as leg 35, is an integral part of an elongated curved support 36 terminating at its upper end in crown portion 20 and at its lower end in leg 35 which may be secured to one side of stand 31. Again, any suitable illuminating means may be provided to illuminate plant 37.

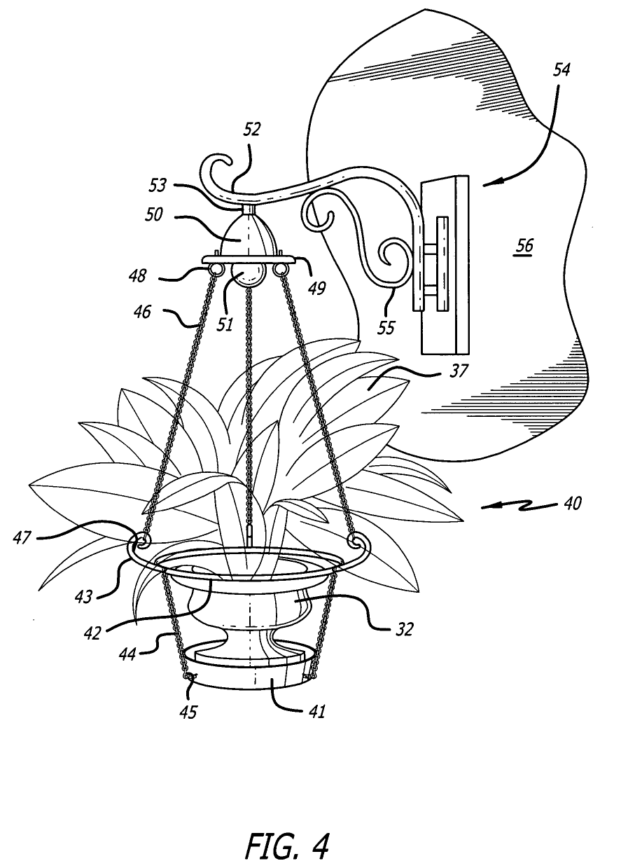

As seen in FIG. 4, where again like numeral refer to like parts of the embodiment of FIG. 3, instead of stand 31, a round pan 41 is provided having pot 32 disposed therein with plant 37 mounted therein. Pot 32 has an upper support member 42 having a plurality of outwardly extending curved chain supports 43. A plurality of support chains 44 are fixed at one end to hooks 45 as the like extending outwardly from the side of pan 41 and at the other end to supports 43. A second plurality of support chains 46 are connected at one end to the upper curved portions 47 of chain supports 44 and at the other end to rings 48 extending downwardly from the bottom of the annular flange 49 of crown portion 50. A conventional light bulb 51 is mounted in the socket (not shown) in crown portion 50 and the latter is secured to the underside of a curved bracket 52 by a post 53. Bracket 52 forms part of a wall sconce 54 having a wall support 55 and a lower integral curved bracket 55′. In this manner, plant holder 40 is mounted to wall and hangs downwardly spaced therefrom. Again, any suitable illuminating means may be used.

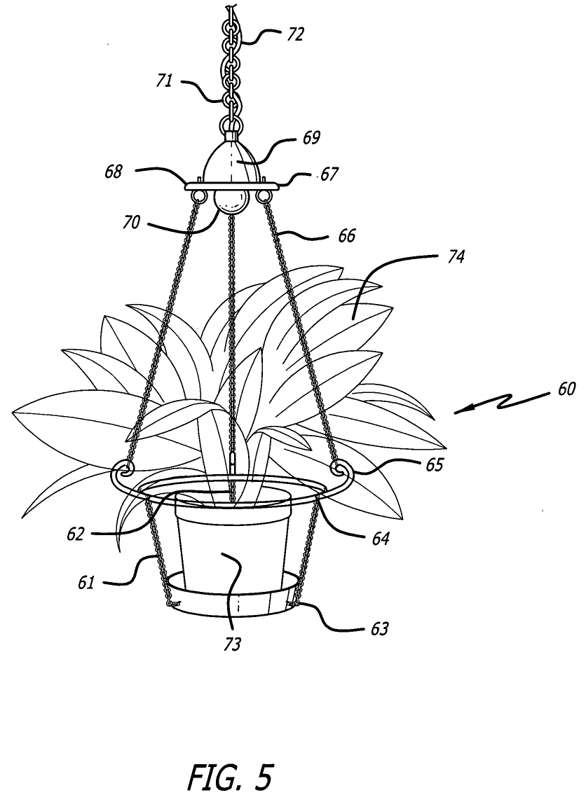

Another lighted plant holder 60 is shown in FIG. 5. Here, a pan 61 is supported by a plurality of chains 62 fixed at one end to a hook 63 or the like extending outwardly from the side of pan 61 and at the other end to a ring 64. Ring 64 has a plurality of curved brackets 65 fixed thereto and extending outwardly therefrom. A plurality of support chains 66 are fixed at one end to brackets 65 and at the other end to hooks 67 extending downwardly from the annular flange 68 of a crown portion 69. A conventional light bulb 70 may be mounted in an electrical socket (not shown) in crown portion 69 and a hanging chain 71, with an electrical conduit 72, supports crown portion 69. A pot 73 rests in pan 61 and a plant 74 is mounted in pot 73.

Although a conventional light bulb is illustrated in FIGS. 1, 3, 4 and 5, all of the plant holders could have a solar panel, as panel 25 in FIG. 2, on any suitable portion of the holder in a position to receive sunlight. It is to be understood that such panels 25 are electronically connected to the bulbs to provide solar power to illuminate the same. The light bulbs may also be powered by a battery in the base or other part of the holder. LEDs may be used and the bulbs may be high or lower voltage, or high or low intensity, and incandescent or fluorescent.

Although particular embodiments of the invention are disclosed, variations thereof may occur to an artisan and the scope of the invention should only be limited by the scope of the appended claims.

1. A plant holder comprising:
a) a support;
b) a pot mounted on said support;
c) a plant mounted in said pot, said plant having an upwardly extending plant surface; and
d) illuminating means associated with said support for providing illumination to said plant, said illuminating means including a light fixture directly above said plant surface and shining downwardly on said plant surface, said light fixture and said plant surface being substantially vertically aligned.

2. The holder of claim 1 wherein said support includes a floor plate, having an upper surface and a flat undersurface, the latter being adapted to rest on a generally horizontal supporting surface.

3. The holder of claim 2 wherein an elongated pole extends upwardly from said plate fixed to the upper surface thereof to a position above said plant, said pole terminating at its upper end in a crown portion having a light socket with a light bulb mounted therein.

4. The holder of claim 3 wherein said pole is curved at the upper and lower end thereof.

5. The holder of claim 3 wherein said pot is hung from the crown portion.

6. The holder of claim 5 wherein said crown portion is bell-shaped having an upper portion fixed to the upper end of said pole and a lower peripheral flange portion, said pot being suspended on chains fixed to both said flange portion and said pot.

7. The holder of claim 1 wherein said illuminating means includes a solar panel also mounted on said support electrically coupled to said light fixture.

8. (canceled)

9. The holder of claim 1 wherein said illuminating means includes an incandescent light bulb.

10. (canceled)

11. The holder of claim 1 wherein said illuminating means is a high intensity light bulb.

12. The holder of claim 1 wherein said illuminating means is powered by a high voltage source.

13. (canceled)

14. The holder of claim 1 wherein said illuminating means is a fluorescent light bulb.

15. The holder of claim 1 wherein said support includes a pan having said pot mounted therein and supported by a plurality of curved legs on a supporting surface.

16. The holder of claim 15 including a curved pole fixed at one end to said pan having a curved end adapted to rest on a supporting surface and the other end curving to a point above said plant and terminating in said illuminating means.

17. The holder of claim 16 wherein said illuminating means is a bell-shaped crown portion having a light bulb socket therein adapted to receive a light bulb.

18. The holder of claim 1 wherein said support includes a pan having said pot mounted therein, and a ring support coupled to said pan by a plurality of spaced chains, said support also including a wall mounted sconce having a bracket extending outwardly therefrom, said illuminating means including a bell-shaped crown portion having an upper end connected to said bracket and a lower end connected to said ring by a plurality of spaced chains, said crown portion having a light socket therein adapted to receive a light bulb.

19. The holder of claim 1 wherein said support includes a pan having said pot disposed therein, said support further including a ring coupled to said pan by a plurality of spaced chains, said ring having a plurality of spaced curved members, said support further including a crown portion having said illuminating means mounted therein, said crown portion having an upper end suspended from a chain and a lower end having a peripheral flange coupled to said curved members by a plurality of spaced chains, said illuminating means includes said light socket mounted in said crown portion adopted to receive a light bulb therein, said light socket being electronically coupled to an electrical conduit extending along the chain from which said crown portion is suspended.

20. (canceled)

21. (canceled)
